(19) United States
(12) Patent Application Publication
(10) Pub. No.: US 2005/0055929 A1
(43) Pub. Date: Mar. 17, 2005

(54) Reversible window shutter for a dwelling or commercial building with windows

(76) Inventor: Richard J. Rude, Landing, NJ (US)

Correspondence Address: Richard J. Rude, 175 Mt. Arlington Blvd., Landing, NJ, 07850, US

(21) Appl. No.: 10/645,145

(22) Filed: Aug. 22, 2003

(51) Int. Cl. E06B 7/08

(52) U.S. Cl. 52/473

(57) ABSTRACT

There are several shutter designs on the market today. The most popular types are louvered and paneled which we will use as examples discussed in this abstract. The objective of this invention is to outline a reversible shutter which is designed to have one style on one side and have a completely different style on the opposite side for example, side A might be louvered and side B might be paneled. The 2 main advantages of this invention are as follows: 1) Both the manufacturer and retailer will benefit from producing, warehousing and stocking fewer units without compromising availability. 2) The homeowner can now purchase a shutter that can be reversed for a completely different shutter look.

### BACKGROUND OF THE INVENTION

The present invention relates to a reversible window shutter for a dwelling or commercial structure with windows. The reversible shutter has particular utility in connection with variable appearances of a dwelling or commercial building, which allows contractors, homeowners, and property managers to reverse the shutter and change the outward appearance of the structure. For example, one side of the shutter may be louvered while the other side may be paneled. A change in appearance might be dictated by mold invasion, staining, or damage to the exposed side of a shutter. This invention is for both functional working and astetic only non-working window shutters.

The new design also has particular benefits on the retail side, by enabling building supply outlets to inventory 50% less product, while offering the same number of choices to customers. This reduction in inventory also leads to better inventory management and significant cost savings.

### DESCRIPTION OF THE PRIOR ART

There is no known prior art for this type of use or application.

### SUMMARY OF THE INVENTION

In view of the foregoing disadvantages inherent with the known types of dwelling shutters now on the market, the present invention provides a flexible design that enables contractors, homeowners and property managers to change the appearance of the dwelling without having to purchase a new set of window shutters. Building materials and supply firms also benefit by having to carry 50% less product, but with the same number of product choices.

As such, the general purpose of the present invention, which will be described subsequently in greater detail, is to provide a new and improved window shutter for dwellings.

To attain this, the present invention essentially comprises two useable sides, which when applied to a dwelling or commercial building, can change its appearance. It is therefore an object of the present invention to provide a new and improved window shutter design for dwellings that has clear advantages over prior art designs, primarily flexibility for the user in choosing a side, and reduced inventory for retailers.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1: Full view of reversible shutter, with sides A and B illustrated

FIG. 2: Full view of reversed shutter, sides A and B illustrated

FIG. 3: Close up view of front sides A and B

FIG. 4: Close up view of reversed shutter, sides A and B

### DESCRIPTION OF THE PREFERRED EMBODIMENT

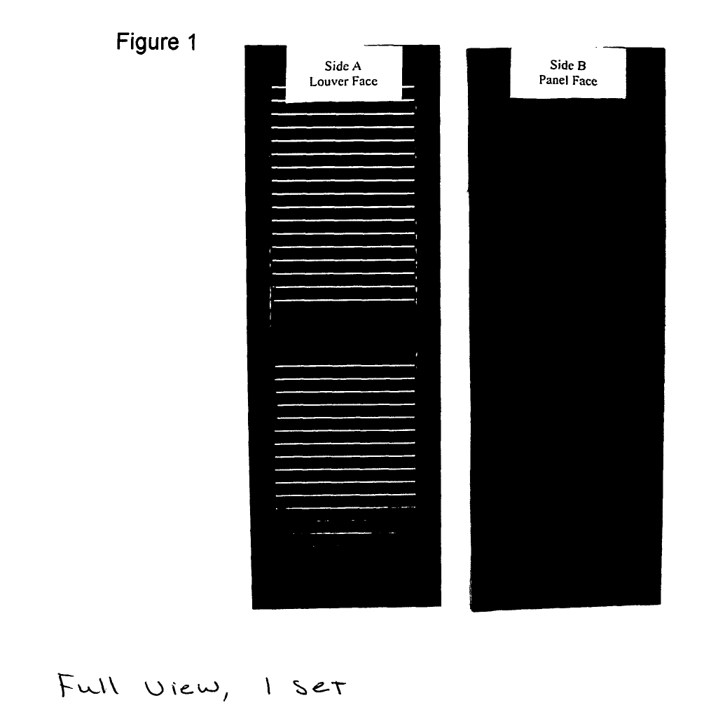

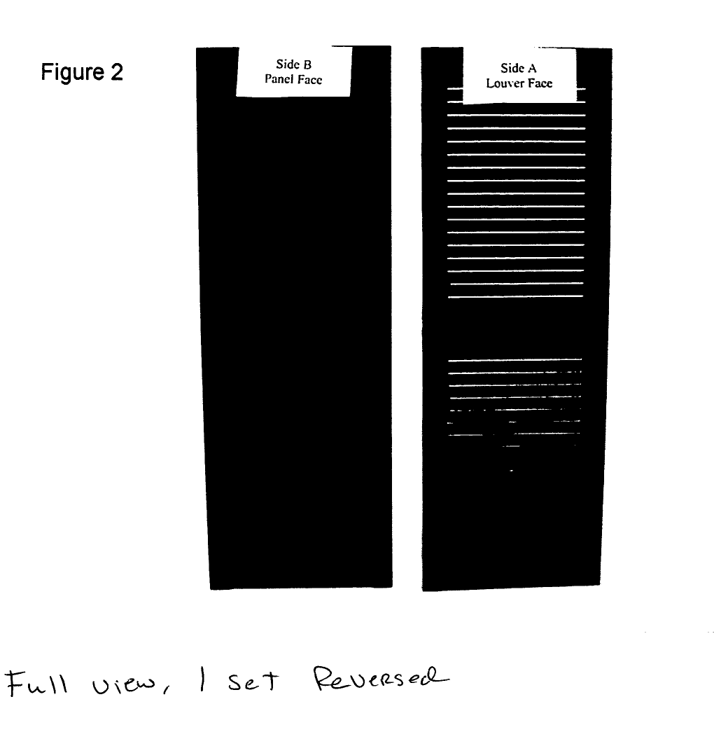

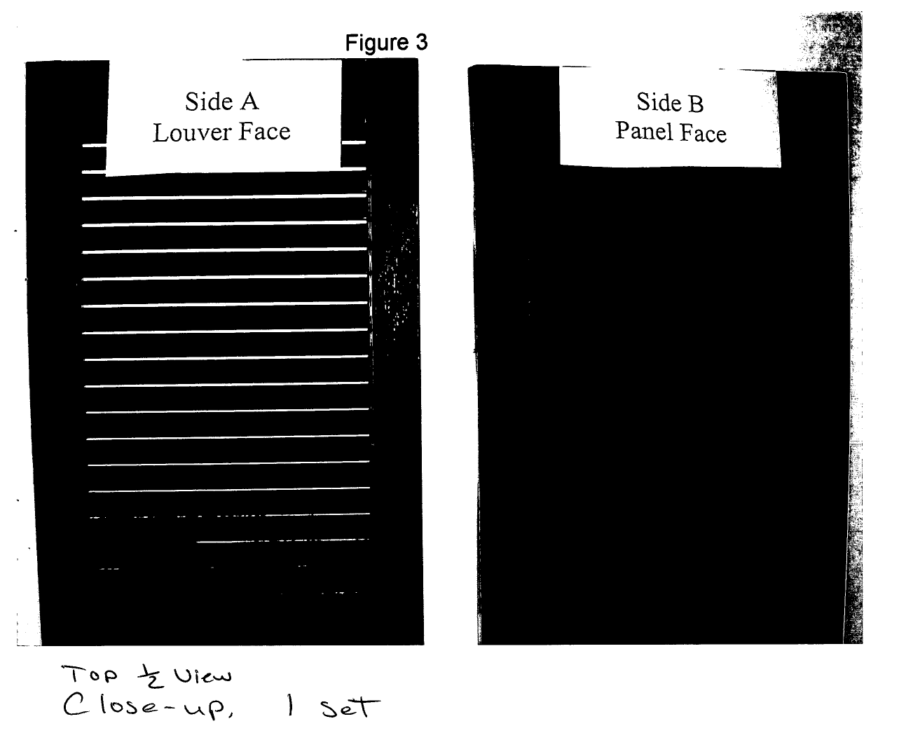

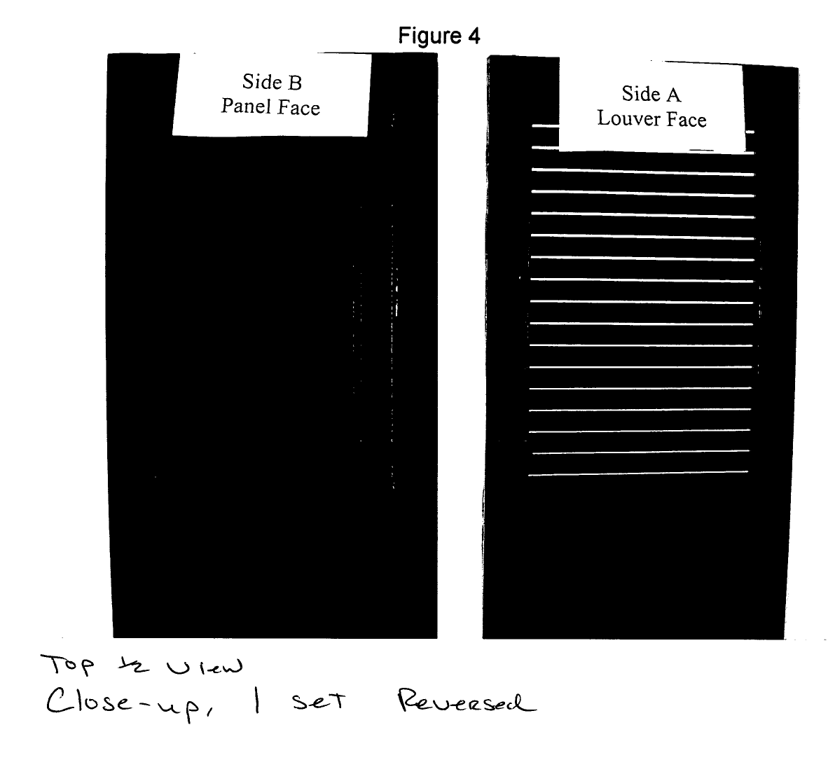

Referring now to the drawings, and particularly to FIGS. 1-4.

All embodiments of the invention shown in FIGS. 1 through 4 can be made of materials such as injection molded fiberglass, graphite, metal, aluminum, plastic, wood, or a combination of two or more of these materials.

In use, it can now be understood that a reversible shutter for dwellings or commercial structures will allow users to easily change the appearance of a dwelling or commercial structure that has windows, and allow retailers more flexibility in stocking shutter products. By using both sides of a shutter, retailers will decrease inventory space by 50%, but will be able to carry the same number of choices for customers.

1. A reversible shutter for dwellings with windows will achieve more flexibility in deciding on the best appearance for a dwelling, and in changing its appearance if necessary.

2. The reversible shutter for dwellings with windows will allow retailers to inventory 50% less product.

3. The reversible shutter for dwellings with windows will allow retailers to carry the same number of choices for customers, but with 50% less product on the shelf.

4. The reversible shutter for dwellings with windows will allow users to change the appearance of the dwelling at any time once the reversible shutters are installed. Reversing shutters after installation is necessary in cases where mold, stains, or damage has occurred to the exposed side of the reversible shutter.

5. The reversible shutter for dwellings with windows is made with material consisting of metal, plastic, wood, injection molded rubber, plastic, fiberglass, or graphite, or any combination of these materials.

6. The reversible shutter for dwellings or commercial buildings with windows can be attached to dwellings with nails, screws, glue, caulk, rivets, snaps or any other patented or non-patented securing device.

7. The reversible shutter for dwellings or commercial buildings with windows can be assembled with components parts or formed, molded, injection molded, extrusion processed, or carved as one piece.

8. The reversible shutter for dwellings or commercial buildings with windows can be produced is common sizes as illustrated below or any custom size desired.
Widths from 6-inches to 20-inches
Lengths from 20-inches to 144-inches
Depths from ¼ inch through to 3 inches

9. The reversible shutter for dwellings or commercial buildings with windows can be produced with, but not limited to louvered, paneled, raised paneled, board and batten and any combination of each or various other looks on each side.

10. The reversible shutter for dwellings or commercial buildings can be mounted to structures sided with brick, masonry block, vinyl siding, aluminum siding, stone, stucco, wood, or and manmade or natural dwelling finish.

11. The reversible shutter for dwellings or commercial buildings can be produced in any color on either side.

12. The reversible shutter for dwellings or commercial buildings can be finished as smooth, wood grain, textured, or a plain paint-ready surface on either side.

13. The reversible shutter for dwellings or commercial buildings can be a product in one or more pieces, which can then be assembled either before or after retail distribution.

14. The reversible shutter for dwellings or commercial buildings can feature a louvered side with either open slats or closed slats on either side.

15. The reversible shutter for dwellings or commercial buildings can be vented or non-vented to allow airflow through the structure, or to allow ambient light to penetrate behind the open louver design.

16. The reversible shutter for dwellings or commercial buildings can be made either solid or hollow depending on the manufacturing method.

17. The reversible shutter for dwellings or commercial buildings allows the end user to change the look from side A to side B without purchasing another set of shutters.
